(19) United States
(12) Patent Application Publication
(10) Pub. No.: US 2005/0073196 A1
(43) Pub. Date: Apr. 7, 2005

(54) Theft prevention system, theft prevention apparatus and power source controller for the system, transport vehicle including theft prevention system, and theft prevention method

(75) Inventor: Tsuyoshi Kamiya, Shizuoka (JP)

Correspondence Address: KEATING & BENNETT LLP, Suite 312, 10400 Eaton Place, Fairfax, VA, 22030, US

(73) Assignee: YAMAHA MOTOR Co. Ltd., Iwata-shi (JP)

(21) Appl. No.: 10/938,738

(22) Filed: Sep. 13, 2004

(30) Foreign Application Priority Data
Sep. 29, 2003 (JP) 2003-338253

(51) Int. Cl. E05B 17/00

(52) U.S. Cl. 307/10.3; 340/426.11

(57) ABSTRACT

A theft prevention system includes a theft prevention apparatus for preventing theft of a movable body, a power source controller that controls a power source for moving the movable body, and a communication line that connects the theft prevention apparatus and the power source controller for data communication. The theft prevention apparatus includes an identification data inputting section into which a user inputs identification data, and an identification data transmitting section transmits the input identification data to the power source controller through the communication line. The power source controller includes an identification data comparing section which performs a comparing process for comparing identification data transmitted through the communication line with identification reference data and determining whether the user inputting the identification data is an authentic user, and a start-up controlling section which permits start-up of the power source when it is determined that the user inputting the identification data is the authentic user.

### BACKGROUND OF THE INVENTION

1. Field of the Invention

The present invention relates to a theft prevention system and a theft prevention method for preventing theft of movable bodies such as transport vehicles including motor vehicles, ships and aircrafts. The present invention further relates to a theft prevention apparatus and a power source controller included in the theft prevention system. The present invention still further relates to a transport vehicle including the theft prevention system.

2. Description of the Related Art

An exemplary theft prevention apparatus (so-called immobilizer) for preventing theft of a motor vehicle is disclosed in Japanese Unexamined Patent Publication (KOKAI) No. 2003-34234. The theft prevention apparatus utilizes fingerprint identification. More specifically, the theft prevention apparatus includes a memory in which a fingerprint of an authentic user of the motor vehicle is registered, a fingerprint reader which reads a fingerprint of a user attempting to use the motor vehicle, an identification section which compares the fingerprint read by the fingerprint reader with the fingerprint registered in the memory, and a control microprocessor which applies an engine start-up permitting command or an engine start-up prohibiting command to an engine ECU (electronic control unit) depending upon the result of the comparison made by the identification section. That is, if the identification section determines that the compared fingerprints match each other, the control microprocessor applies an engine start-up permitting signal to the engine ECU. On the other hand, if the identification section determines that the compared fingerprints do not match each other, the control microprocessor applies an engine start-up prohibiting signal to the engine ECU.

In general, motor vehicles have recently been designed such that a plurality of electronic devices mounted on each motor vehicle are connected to each other for mutual data communication through a local area network provided in the motor vehicle (mobile LAN). Where the aforementioned prior art theft prevention apparatus is mounted in such a motor vehicle, communication between the theft prevention apparatus and the engine ECU is achieved through the mobile LAN.

However, it is easy to intercept data transferred through the mobile LAN and to input data to the mobile LAN from the outside. Hence, there is a possibility that a thief could intercept an engine start-up permitting signal that is output from a theft prevention apparatus of the same type, generate the same signal as the intercepted engine start-up permitting signal from a signal generator, and input the generated signal to a mobile LAN of a motor vehicle which the thief attempts to steal. Thus, the thief could evade the fingerprint identification process to start up the engine. In this manner, the thief could successfully steal the motor vehicle by evading the theft prevention function.

### SUMMARY OF THE INVENTION

To overcome the problems described above, preferred embodiments of the present invention provide a movable body theft prevention system and a theft prevention method which improve a theft preventing effect by making it more difficult to start up a power source of a movable body by evading a theft preventing function, a theft prevention apparatus and a power source controller which define the theft prevention system, and a transport vehicle including the theft prevention system.

A movable body theft prevention system according to a preferred embodiment of the present invention includes a theft prevention apparatus for preventing theft of a movable body, a power source controller which controls a power source for moving the movable body, and a communication line which connects the theft prevention apparatus and the power source controller for data communication. The theft prevention apparatus further includes an identification data inputting unit into which a user inputs identification data, and an identification data transmitting unit which transmits the identification data that is input into the identification data inputting unit to the power source controller through the communication line. The power source controller includes an identification data receiving unit which receives the identification data transmitted from the identification data transmitting unit through the communication line, an identification reference data storing unit which stores identification reference data to be compared with the identification data received by the identification data receiving unit, an identification data comparing unit which performs a comparing process for comparing the identification data received by the identification data receiving unit with the identification reference data stored in the identification reference data storing unit and for judging whether the user inputting the identification data is an authentic user, and a start-up controlling unit which permits start-up of the power source when the identification data comparing unit determines that the user inputting the identification data is the authentic user.

With this arrangement, the identification data that is input into the identification data inputting unit provided in the theft prevention apparatus is transmitted to the power source controller from the identification data transmitting unit through the communication line. The identification data transmitted to the power source controller is received by the identification data receiving unit, and compared with the identification reference data stored in the identification reference data storing unit for judging whether or not the identification data is input by the authentic user. If the identification data is input by the authentic user, the start-up controlling unit starts up the power source of the movable body.

Identification data that is input by the authentic user appears on the communication line only when the authentic user attempts to start up the power source of the movable body. That is, when a thief attempts to steal the movable body, the identification data never appears on the communication line in the absence of the authentic user.

Therefore, a power source start-up command signal does not appear on the communication line, unlike the case where the identification data comparing process is performed in the theft prevention apparatus. This makes it impossible to intercept the power source start-up command signal and to start up the power source even if a power source start-up command signal generated from a signal generator is input to the communication line.

Thus, it is very difficult to start up the power source of the movable body by evading the theft preventing function, which thereby greatly improves theft prevention.

A typical example of the movable body is a transport vehicle which transports people and/or goods. Examples of the transport vehicle include ground transport vehicles such as motor vehicles (including motorcycles), water transport vehicles such as ships, and air transport vehicles such as aircrafts.

Examples of power sources therefore include those capable of moving such transport vehicles. Specifically, the power source may be an internal-combustion engine, an electric motor, a fuel cell, a jet engine, a gas turbine engine, or other suitable power sources.

An example of the communication line is a local area network installed in the movable body but other communication lines can be used.

The theft prevention apparatus preferably further includes a first identification program storing unit which stores an identification program defining the comparing process to be performed by the identification data comparing unit, and an identification program transmitting unit which transmits the identification program stored in the first identification program storing unit to the power source controller through the communication line. The power source controller preferably further includes an identification program receiving unit which receives the identification program transmitted from the identification program transmitting unit through the communication line, and a second identification program storing unit which stores the identification program received by the identification program receiving unit. In this case, the identification data comparing unit preferably includes a program implementing unit which performs the comparing process according to the identification program stored in the second identification program storing unit.

With this arrangement, the identification data comparing unit provided in the power source controller is operative according to the identification program to perform the comparing process. The identification program is stored in the first identification program storing unit provided in the theft prevention apparatus. The identification program is transmitted to the power source controller through the communication line by the identification program transmitting unit. The power source controller includes the identification program receiving unit which receives the identification program through the communication line. The identification program received by the identification program receiving unit is stored in the second identification program storing unit, and used for the comparing process by the identification data comparing unit.

Thus, the theft prevention system is configured such that the identification program is transmitted to the power source controller from the theft prevention apparatus. Therefore, the theft prevention system can be modified simply by replacement of the theft prevention apparatus without replacing the power source controller. For example, a new theft prevention apparatus which is operative in a different manner from the previous theft prevention apparatus can be used in combination with the previous power source controller.

More specifically, when a new theft prevention apparatus having an improved identification data inputting unit is used in combination with the previous power source controller, for example, an identification program for the improved identification data inputting unit is transmitted to the power source controller from the new theft prevention apparatus, whereby the function of the improved identification data inputting unit is efficiently utilized.

If the previous theft prevention apparatus malfunctions and is replaced with a new theft prevention apparatus of the same type, the new theft prevention apparatus may be installed with a version-upgraded identification program. In this case, the version-upgraded identification program is transmitted to the power source controller, such that the identification data comparing process is improved. Thus, the theft prevention system is flexibly adaptable to the replacement of the theft prevention apparatus.

The program implementing unit preferably includes, for example, a microprocessor.

The power source controller preferably has at least a start-up lock state in which the start-up of the power source is prohibited by the start-up controlling unit and a start-up unlock state where the start-up of the power source is permitted by the start-up controlling unit. The power source controller operates in the start-up unlock state when the identification data comparing unit determines that the user inputting the identification data is the authentic user. In this case, the power source controller preferably further includes a unit which permits writing of the identification program to the second identification program storing unit when the power source controller is in the start-up unlock state, and prohibits writing of the identification program to the second identification program storing unit when the power source controller is in a state other than the start-up unlock state.

With this arrangement, writing of the identification program to the second identification program storing unit is permitted only when the power source controller is in the start-up unlock state. Therefore, the identification data processing to be performed in the power source controller cannot be altered without a user authentication process by an authentic user. Thus, the authentic user can replace the theft prevention apparatus, while a third person who is not an authentic user cannot replace the theft prevention apparatus.

The power source controller preferably further includes a unit which permits switching from the start-up unlock state to the start-up lock state by turning off the power supply to the power source controller. Since the power source controller is automatically brought into the start-up lock state by turning off the power supply, the theft of the movable body is effectively prevented.

The power source controller preferably has, in addition to the start-up lock state and the start-up unlock state, a theft preventing function disabled state where the theft preventing function is temporarily disabled. That is, even if the power supply to the power source controller is turned off in the theft preventing function disabled state, for example, the power source controller is not brought into the start-up lock state. The theft preventing function disabled state is convenient when maintenance service is carried out for repair or inspection of the movable body.

The power source controller preferably further includes a unit which permits switching to the theft preventing function disabled state when the power source controller is in the start-up unlock state, and prohibits the switching to the theft preventing function disabled state when the power source controller is in a state other than the start-up unlock state.

The theft prevention apparatus preferably further includes an identification program encrypting unit which encrypts the identification program stored in the first identification program storing unit. In this case, the identification program transmitting unit transmits the identification program encrypted by the identification program encrypting unit to the power source controller through the communication line. Further, the identification program receiving unit receives the encrypted identification program. The power source controller preferably further includes an identification program decrypting unit which decrypts the encrypted identification program. In this case, the second identification program storing unit stores the identification program decrypted by the identification program decrypting unit.

With this arrangement, the identification program stored in the theft prevention apparatus is encrypted by the identification program encrypting unit, and transmitted to the communication line. This prevents the theft of the specific content of the identification program through interception from the communication line, thereby further improving the theft preventing effect. Even if the specific content of the identification program is stolen, the movable body cannot be easily stolen. This is because the command signal for directly starting up the power source does not appear on the communication line according to preferred embodiments of the present invention.

The power source controller preferably further includes an encryption key generating unit which generates encryption key data to be used for the encryption of the identification program, and a unit which transmits the encryption key data generated by the encryption key generating unit to the theft prevention apparatus through the communication line. In this case, the theft prevention apparatus preferably further includes a unit which receives the encryption key data transmitted from the power source controller through the communication line. The identification program encrypting unit preferably encrypts the identification program with the use of the received encryption key data, and the identification program decrypting unit preferably decrypts the encrypted identification program with the use of decryption key data corresponding to the encryption key data.

With this arrangement, the identification program is encrypted using the encryption key data generated by the encryption key generating unit provided in the power source controller, such that decryption of the encrypted identification program is more difficult. Since the encryption key data is generated in the power source controller, a correlation between the encryption key data and the decryption key data is easily derived in the power source controller. Therefore, the power source controller is not required to use fixed encryption key data, but rather may select the encryption key data from a plurality of types of encryption key data and apply the selected encryption key data to the theft prevention apparatus. Even if the encryption key data is intercepted on the communication line, the decryption of the encrypted identification program transmitted from the theft prevention apparatus is very difficult by using decryption key data different from the encryption key data.

The encryption key generating unit preferably generates the encryption key data on the basis of intrinsic information of the movable body, such as the movement distance of the movable body (e.g., the traveling distance of a motor vehicle) obtained at the time of the generation of the encryption key data. This makes it much more difficult to decrypt the encrypted identification program. If the encryption key data is generated on the basis of a combination of a random number and the intrinsic information of the movable body obtained at the time of generation of the encryption key data, the decryption of the encrypted identification program is even more difficult.

It is necessary to transmit the identification program to the power source controller from the theft prevention apparatus only when the theft prevention apparatus is newly connected to the communication line. Therefore, the encryption key generating unit preferably generates the encryption key data in response to detection of the connection of the theft prevention apparatus to the communication line. The generation and transmission of the encryption key data may be repeated a plurality of times for insurance against an error in the transmission of the identification program or other malfunction. However, the number of times of the generation and transmission of the encryption key data is preferably limited to a predetermined number (e.g., three times).

The identification data inputting unit preferably includes a biometric information detecting unit which detects biometric information of the user and outputs the detected biometric information as the identification data.

With this arrangement, the biometric information of the user is used as the identification data, thereby further improving the theft preventing effect. Where the theft prevention system is configured such that the identification program is transmitted to the power source controller from the theft prevention apparatus as described above, an outstanding theft preventing effect is provided. That is, when a theft prevention apparatus of a new type having an improved biometric information detecting unit becomes available, the new theft prevention apparatus can be installed and used in place of the previous theft prevention apparatus. Thus, rapidly advancing biometric information identification techniques are effectively utilized for the prevention of the theft of the movable body.

Besides the biometric information detecting unit, a personal identification number inputting unit (e.g., a keyboard), for example, may be used as the identification data inputting unit. The identification data inputting unit is not necessarily required to include a single type of identification data inputting unit, but rather may include two or more types of identification data inputting units.

A theft prevention apparatus according to preferred embodiments of the present invention is mountable on a movable body which includes a power source controller for controlling a power source for moving the movable body and a communication line connected to the power source controller for data communication, and is connectable to the communication line for data communication. The theft prevention apparatus includes an identification data inputting unit into which a user inputs identification data, and an identification data transmitting unit which transmits the identification data inputted into the identification data inputting unit to the power source controller through the communication line. That is, an identification data comparing process is not performed in the theft prevention apparatus, but rather is performed in the power source controller. This makes it difficult to start up the power source of the movable body by evading the function of the theft prevention apparatus, thereby greatly improving the theft preventing effect.

The theft prevention apparatus preferably further includes an identification program storing unit which stores therein an identification program defining a process for comparing the identification data input into the identification data inputting unit, and an identification program transmitting unit which transmits the identification program stored in the identification program storing unit to the power source controller through the communication line. Thus, even if the theft prevention apparatus is replaced with a new theft prevention apparatus, the power source controller can perform the identification data comparing process in a manner suitable for the new theft prevention apparatus.

The apparatus preferably further includes a unit which receives encryption key data transmitted from the power source controller through the communication line, and an identification program encrypting unit which encrypts the identification program stored in the identification program storing unit with the use of the received encryption key data. In this case, the identification program transmitting unit transmits the identification program encrypted by the identification program encrypting unit to the power source controller through the communication line. This arrangement makes it difficult to decrypt the identification program transmitted through the communication line, thereby further improving the theft preventing effect.

The identification data inputting unit preferably includes a biometric information detecting unit which detects biometric information of the user and outputs the detected biometric information as the identification data.

A power source controller according to preferred embodiments of the present invention controls a power source for moving a movable body and performs data communication with a theft prevention apparatus through a communication line provided in the movable body. The power source controller includes an identification data receiving unit which receives identification data input by a user from the theft prevention apparatus through the communication line, an identification reference data storing unit which stores identification reference data to be compared with the identification data received by the identification data receiving unit, an identification data comparing unit which performs a comparing process for comparing the identification data received by the identification data receiving unit with the identification reference data stored in the identification reference data storing unit and for judging whether the user inputting the identification data is an authentic user, and a start-up controlling unit which permits start-up of the power source when the identification data comparing unit determines that the user inputting the identification data is the authentic user.

With this arrangement, the identification data comparing process is not performed in the theft prevention apparatus, but rather is performed in the power source controller. This makes it difficult to evade the theft preventing function, thereby greatly improving the theft preventing effect.

The power source controller preferably further includes an identification program receiving unit which receives an identification program transmitted from the theft prevention apparatus through the communication line, and an identification program storing unit which stores therein the identification program received by the identification program receiving unit. In this case, the identification data comparing unit preferably includes a program implementing unit which performs the comparing process according to the identification program stored in the identification program storing unit. With this arrangement, the power source controller is flexibly adaptable to replacement of the theft prevention apparatus.

The power source controller preferably has at least a start-up lock state where the start-up of the power source is prohibited by the start-up controlling unit and a start-up unlock state where the start-up of the power source is permitted by the start-up controlling unit. The power source controller operates in the start-up unlock state when the identification data comparing unit determines that the user inputting the identification data is the authentic user. In this case, the power source controller preferably further includes a unit which permits writing of the identification program to the identification program storing unit when the power source controller is in the start-up unlock state, and prohibits the writing of the identification program to the identification program storing unit when the power source controller is in a state other than the start-up unlock state. With this arrangement, the authentic user may replace the theft prevention apparatus, while a third person who is not an authentic user is prevented from replacing the theft prevention apparatus.

Where the theft prevention apparatus transmits an encrypted identification program to the power source controller through the communication line, the power source controller preferably further includes an encryption key generating unit which generates encryption key data to be used for encryption of the identification program, a unit which transmits the encryption key data generated by the encryption key generating unit to the theft prevention apparatus through the communication line, and an identification program decrypting unit which decrypts the encrypted identification program with the use of decryption key data corresponding to the encryption key data. The identification program storing unit preferably stores the identification program decrypted by the identification program decrypting unit. This arrangement makes it difficult to decrypt the identification program transmitted through the communication line, thereby enhancing the theft preventing effect.

A transport vehicle having a power source for movement thereof according to a preferred embodiment of the present invention includes a theft prevention apparatus for preventing theft of the transport vehicle, a power source controller which controls the power source, and a communication line which connects the theft prevention apparatus and the power source controller for data communication. The theft prevention apparatus includes an identification data inputting unit into which a user inputs identification data, and an identification data transmitting unit which transmits the identification data input into the identification data inputting unit to the power source controller through the communication line. The power source controller includes an identification data receiving unit which receives the identification data transmitted from the identification data transmitting unit through the communication line, an identification reference data storing unit which stores identification reference data to be compared with the identification data received by the identification data receiving unit, an identification data comparing unit which performs a comparing process for comparing the identification data received by the identification data receiving unit with the identification reference data stored in the identification reference data storing unit and for judging whether the user inputting the identification data is an authentic user, and a start-up controlling unit which permits start-up of the power source when the identification data comparing unit determines that the user inputting the identification data is the authentic user.

This arrangement makes it difficult to start up the power source of the transport vehicle by evading the theft preventing function, thereby effectively preventing the theft of the transport vehicle.

The theft prevention apparatus preferably further includes a first identification program storing unit which stores an identification program defining the comparing process to be performed by the identification data comparing unit, and an identification program transmitting unit which transmits the identification program stored in the first identification program storing unit to the power source controller through the communication line. The power source controller preferably further includes an identification program receiving unit which receives the identification program transmitted from the identification program transmitting unit through the communication line, and a second identification program storing unit which stores the identification program received by the identification program receiving unit. In this case, the identification data comparing unit preferably includes a program implementing unit which performs the comparing process according to the identification program stored in the second identification program storing unit. With this arrangement, the transport vehicle is flexibly adaptable to replacement of the theft prevention apparatus.

A theft prevention method according to a preferred embodiment of the present invention includes the steps of connecting a theft prevention apparatus to a power source controller through a communication line for data communication, the theft prevention apparatus preventing theft of a movable body, the power source controller controlling a power source for moving the movable body, allowing a user to input identification data into an identification data inputting unit provided in the theft prevention apparatus, transmitting the identification data input into the identification data inputting unit to the power source controller through the communication line, storing identification reference data in an identification reference data storing unit provided in the power source controller, causing an identification data comparing unit provided in the power source controller to perform an identification data comparing process for comparing the identification data transmitted from the theft prevention apparatus through the communication line with the identification reference data stored in the identification reference data storing unit and for judging whether the user inputting the identification data is an authentic user, and permitting start-up of the power source when it is determined in the identification data comparing step that the user inputting the identification data is the authentic user. This method makes it difficult to start up the power source by evading the theft preventing function, thereby greatly improving the theft preventing effect.

The method preferably further includes the steps of transmitting an identification program defining the comparing process to be performed by the identification data comparing unit to the power source controller from the theft prevention apparatus through the communication line, and storing the identification program in an identification program storing unit provided in the power source controller. In this case, the identification data comparing step preferably includes the step of comparing the identification data transmitted from the theft prevention apparatus with the identification reference data stored in the identification reference data storing unit according to the identification program stored in the identification program storing unit. This method is flexibly adaptable to replacement of the theft prevention apparatus.

Other features, elements, characteristics and advantages of the present invention will become more apparent from the following detailed description of the preferred embodiments with reference to the attached drawings.

### BRIEF DESCRIPTION OF THE DRAWINGS

FIG. 1 is a block diagram illustrating the electrical construction of a motor vehicle mounted with a motor vehicle theft prevention system according to a preferred embodiment of the present invention;

FIG. 2 is a flow chart for explaining a process for unlocking an engine to move a motor vehicle and, after stopping or parking the motor vehicle, locking the engine;

FIG. 3 is a flow chart illustrating the continuation of the process shown in FIG. 2;

FIG. 4 is a flow chart for explaining a process for temporarily disabling the function of a theft prevention apparatus;

FIG. 5 is a flow chart for explaining a process for registering new identification reference data;

FIG. 6 is a flow chart illustrating the continuation of the process shown in FIG. 5;

FIG. 7 is a flow chart for explaining a process for replacing the theft prevention apparatus; and

FIG. 8 is a flow chart illustrating the continuation of the process shown in FIG. 7.

### DETAILED DESCRIPTION OF PREFERRED EMBODIMENTS

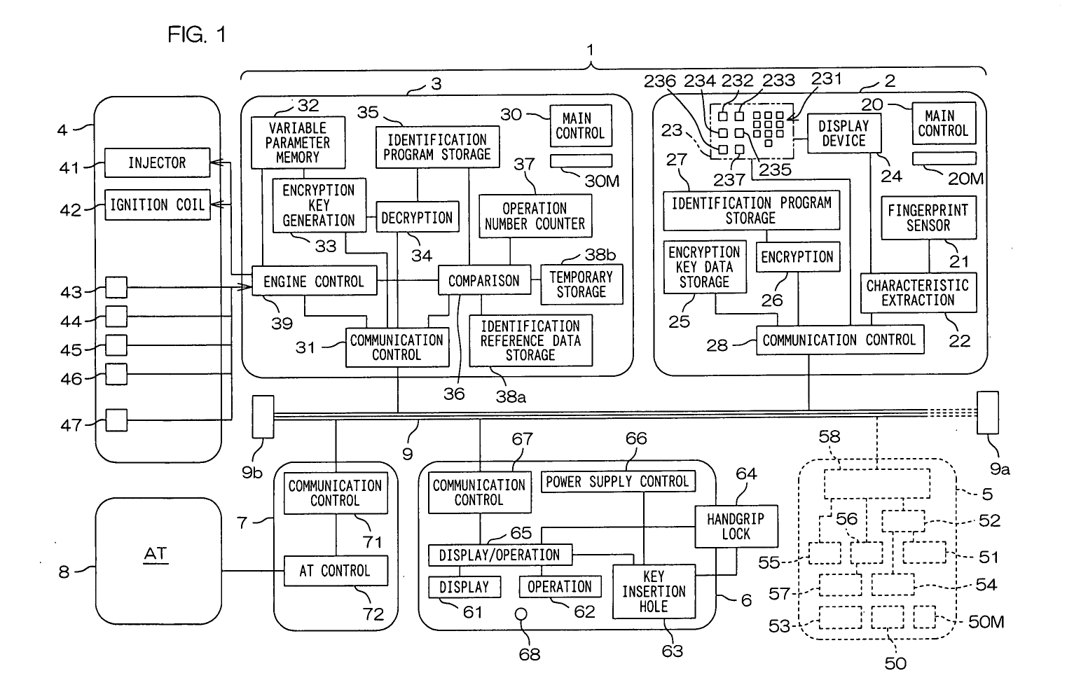

FIG. 1 is a block diagram illustrating the electrical construction of a motor vehicle mounted with a motor vehicle theft prevention system 1 (so-called immobilizer) according to a preferred embodiment of the present invention. The motor vehicle may be a four-wheeled automobile or a motorcycle, for example. In the following description, the motor vehicle theft prevention system is preferably applied to a motorcycle by way of example.

The motor vehicle theft prevention system 1 preferably includes a replaceable theft prevention apparatus 2, and an engine ECU (electronic control unit) 3 as a power source controller which controls the operation of an engine 4 as a power source fixed to a vehicle body for moving the motor vehicle. The theft prevention apparatus 2 and the engine ECU 3 are electrically connected to a mobile LAN (local area network) 9 as a communication line. That is, the theft prevention apparatus 2 and the engine ECU 3 each include a microprocessor which performs program-based processes, and which transmit data communication through the mobile LAN 9. Reference characters 9a, 9b denote terminal resistors.

A meter module 6 and an AT control unit 7 are also connected to the mobile LAN 9. The meter module 6 includes a display for monitoring the operation state of the motor vehicle, and various operation switches integrated therein for operating the motor vehicle. The AT control unit 7 controls the operation of an AT (automatic transmission) 8.

When replacement of the theft prevention apparatus 2 is required due to malfunction, version upgrade or other factors, a new theft prevention apparatus 5 is connected in place of the previous theft prevention apparatus 2 to the mobile LAN 9.

The theft prevention apparatus 2 includes, for example, a fingerprint sensor 21 which detects a fingerprint image data, a characteristic extracting section 22 which extracts the characteristic of the fingerprint from the image data detected by the fingerprint sensor 21, a plurality of operation buttons 23 for inputting a personal identification number and other suitable data, and a display device 24 which displays various information. The fingerprint sensor 21 and the characteristic extracting section 22 function as an identification data inputting unit which detects a fingerprint of a user and outputs characteristic data of the fingerprint (biometric information data) as identification data. The operation buttons 23 function as another identification data inputting unit which receives and outputs a personal identification number that is input by the user.

The theft prevention apparatus 2 further includes an encryption key data storing section 25 for storing encryption key data transmitted from the engine ECU 3 through the mobile LAN 9, an encrypting section 26 defining an identification program encrypting unit which encrypts an identification program (to be described later) with the use of the encryption key data, an identification program storing section 27 defining a first identification program storing unit which stores the identification program not subjected to the encryption, a communication control section 28 for transmitting and receiving data and signals with respect to other units through the mobile LAN 9, and a main control section 20 which controls the aforementioned sections. The theft prevention apparatus 2 further includes a state data memory 20M for storing state data indicative of one of an engine lock state, an engine unlock state and a theft preventing function disabled state. The engine lock state (start-up lock state), the engine unlock state (start-up unlock state) and the theft preventing function disabled state are assumed by the engine ECU 3. In the engine lock state, the engine ECU 3 prohibits the start-up of the engine. In the engine unlock state, the engine ECU 3 permits the start-up of the engine. In the theft preventing function disabled state, the theft preventing function is disabled or the engine is not locked even if an ignition key is off (in a key-off state).

The functions of the main control section 20, the characteristic extracting section 22 and the encrypting section 26 are provided by predetermined programs implemented by the microprocessor provided in the theft prevention apparatus 2.

The characteristic data extracted by the characteristic extracting section 22 is transmitted to the engine ECU 3 from the communication control section 28 through the mobile LAN 9, and defines the identification data for identification of the user. The personal identification number input into the operation buttons 23 is also transmitted as identification data to the engine ECU 3 from the communication control section 28 through the mobile LAN 9. That is, the communication control section 28 functions as an identification data transmitting unit for transmitting the identification data to the engine ECU 3. The communication control section 28 also functions as a unit for receiving the encryption key data from the engine ECU 3, and functions as an identification program transmitting unit for transmitting the identification program encrypted by the encrypting section 26 to the engine ECU 3.

The operation buttons 23 include 0 to 9 numeric keys (ten keys) 231, a function disabling button 232 for temporarily disabling the function (theft preventing function) of the theft prevention apparatus 2, a function disablement confirming button 233 for confirming the disablement of the theft preventing function, an enabling button 234 for enabling the theft preventing function, a setting change button 235 for registering or updating identification reference data, a personal identification number setting button 236 to be operated for setting a personal identification number as the identification reference data, and a biometric information registering button 237 to be operated for registering biometric information data (fingerprint characteristic data) as the identification reference data. The operation buttons 23 may be defined by buttons displayed on the display device 24 and a touch panel provided on a screen of the display device 24 in combination. In this case, all of the operation buttons 23 are not necessarily required to be simultaneously displayed on the screen of the display device 24. For example, the numeric keys 231 may be displayed only on a personal identification number inputting screen for inputting the personal identification number, but not on the other screens.

The engine ECU 3 includes a main control section 30 which controls respective sections provided in the engine ECU 3, a communication control section 31 which transmits and receives data and signals from the other units through the mobile LAN 9, a memory 32 which stores variable parameters, and an encryption key generating section 33 which generates dynamically variable encryption key data using the parameters stored in the memory 32. The parameters to be stored in the memory 32 include data varying with time during use of the motor vehicle, for example, data of a timer (time) managed by the engine ECU 3 and data of a traveling distance of the motor vehicle. The encryption key generating section 33 generates the dynamically variable encryption key data by using the parameters stored in the memory 32 and a random number in combination. The encryption key data is transferred to the theft prevention apparatus 2, and the identification program encrypted with the use of the encryption key data is transmitted to the engine ECU 3 from the theft prevention apparatus 2 through the mobile LAN 9.

The engine ECU 3 further includes a decrypting section 34 defining an identification program decrypting unit which decrypts the encrypted identification program, an identification program storing section 35 defining a second identification program storing unit which stores the decrypted identification program, a comparing section 36 defining an identification data comparing unit which performs a comparing process on the identification data transmitted from the theft prevention apparatus 2 through the mobile LAN 9, an operation number counter 37 which counts the number of times that an operation is performed by the user according to the result of the comparison, an identification reference data storing section 38a which temporarily stores the identification reference data to be used for the comparing process, a temporary storage section 38b which temporarily stores the identification data to be compared in the comparing section 36, an engine control section 39 defining a start-up controlling unit which controls the start-up and stop of the engine 4 on the basis of the result of the comparison made by the comparing section 36, and a state data memory 30M which stores the state data which indicates one of the engine lock state, the engine unlock state and the theft preventing function disabled state. The decrypting section 34 decrypts the encrypted identification program received from the theft prevention apparatus 2 through the mobile LAN 9 based on the encryption key data generated by the encryption key generating section 33 (more specifically, based on the decryption key data corresponding to the encryption key data).

The comparing section 36 compares the identification data with the identification reference data according to the decrypted identification program. Since the identification program is applied from the theft prevention apparatus 2, the comparing section 36 performs the comparing process in a manner specific to the theft prevention apparatus 2. In other words, the identification program enables the comparing section 36 of the engine ECU 3 to function as an identification data comparing unit dedicated to at least the theft prevention apparatus 2 now in use.

The functions of the main control section 30, the encryption key generating section 33, the decrypting section 34 and the comparing section 36 are respectively defined by predetermined program-based processes implemented by the microprocessor provided as a program implementing unit in the engine ECU 3.

The communication control section 31 functions as an identification data receiving unit for receiving the identification data transmitted from the theft prevention apparatus 2, as an identification program receiving unit for receiving the identification program transmitted from the theft prevention apparatus 2, and as a unit for transmitting the encryption key data generated by the encryption key generating section 33 to the theft prevention apparatus 2.

When the theft prevention apparatus 2 is replaced with the new theft prevention apparatus 5, the new theft prevention apparatus 5 transmits an identification program specific thereto to the engine ECU 3 through the mobile LAN 9. When this identification program is registered in the engine ECU 3, the comparing section 36 of the engine ECU 3 functions as an identification data comparing unit dedicated to the new theft prevention apparatus 5.

The new theft prevention apparatus 5 has substantially the same basic configuration as the theft prevention apparatus 2, except that the fingerprint sensor and the characteristic extracting section, for example, have different capabilities. That is, the new theft prevention apparatus 5 includes a fingerprint sensor 51, a characteristic extracting section 52, operation buttons 53, a display device 54, an encryption key data storing section 55, an encrypting section 56, an identification program storing section 57, a communication control section 58, a main control section 50 and a state data memory 50M.

The theft prevention apparatus 2 is replaceable with the theft prevention apparatus 5 as described above. This provides the following advantages. There are various human characteristic sensors for detecting biometric information of the user, such as a fingerprint sensor, a retinal blood vessel sensor and an iris sensor. The preference of the human characteristic sensors varies from user to user. Since the theft prevention apparatuses 2 and 5 are replaceable, the user can select one of the theft prevention apparatuses including a preferred sensor and mount the selected theft prevention apparatus on the vehicle body. Further, biometric personal identification techniques are rapidly advancing. With improvements in sensors and identification algorithms, the identification ratio is constantly being improved. Therefore, replacement with a theft prevention apparatus having an improved performance sensor or an improved performance identification algorithm is a natural demand of users, and greatly improves the theft preventing effect. Further, the replaceability of the theft prevention apparatus increases the design flexibility of the entire motor vehicle theft prevention system.

The characteristic data to be extracted varies depending on the biometric information to be detected and, thus, the comparing process correspondingly varies. Further, the characteristic data to be extracted varies depending on the sensor and the identification algorithm to be used and, thus, the comparing process correspondingly varies. Therefore, if the theft prevention apparatus is replaced, the identification data comparing process should correspondingly be updated to provide the function of the new theft prevention apparatus. In this preferred embodiment, the theft prevention apparatuses 2, 5 each store therein a specific identification program, which is transferred to the engine ECU 3. Then, the comparing process is performed according to the identification program in the engine ECU 3.

When the new theft prevention apparatus 5 is connected to the mobile LAN 9 for use, as will be described later, a preparatory operation should be performed with the previous theft prevention apparatus 2 also being connected to the mobile LAN 9. That is, the engine lock state where the start-up of the engine 4 is prohibited should be cancelled through the authentication of the user with the use of the previous theft prevention apparatus 2. The identification program in the engine ECU 3 can be updated to the identification program for the new theft prevention apparatus 5 only in the engine unlock state.

The engine 4 includes an injector 41, an ignition coil 42, an engine rotation pulser (pulse sensor) 43, an oxygen sensor 44, an intake air amount sensor 45, a throttle position sensor 46, and an engine water temperature sensor 47, which are controlled by the engine control section 39 of the engine ECU 3.

The meter module 6 includes a display section 61 which displays measurements of meters such as a speed meter, an operation section 62 including buttons and switches, a key insertion hole (ignition key cylinder) 63 in which the ignition key is inserted, a display/operation section 65 which controls the display section 61, the operation section 62 and the ignition key cylinder 63, a power supply control section 66 which controls power supply to the meter module 6, a communication control section 67 which transmits and receives data and signals to and from the other units through the mobile LAN 9, and a starter button 68 for the start-up of the engine 4. Further, the meter module 6 is connected to a handgrip lock device 64 via the key insertion hole 63. The meter module 6 includes a microprocessor, and the functions of the display/operation section 65 and the power supply control section 66 are provided by predetermined program-based processes performed by the microprocessor.

The AT control unit 7 includes a communication control section 71 which transmits and receives data and signals to and from the other units through the mobile LAN 9, and an AT control section 72 which controls the AT 8.

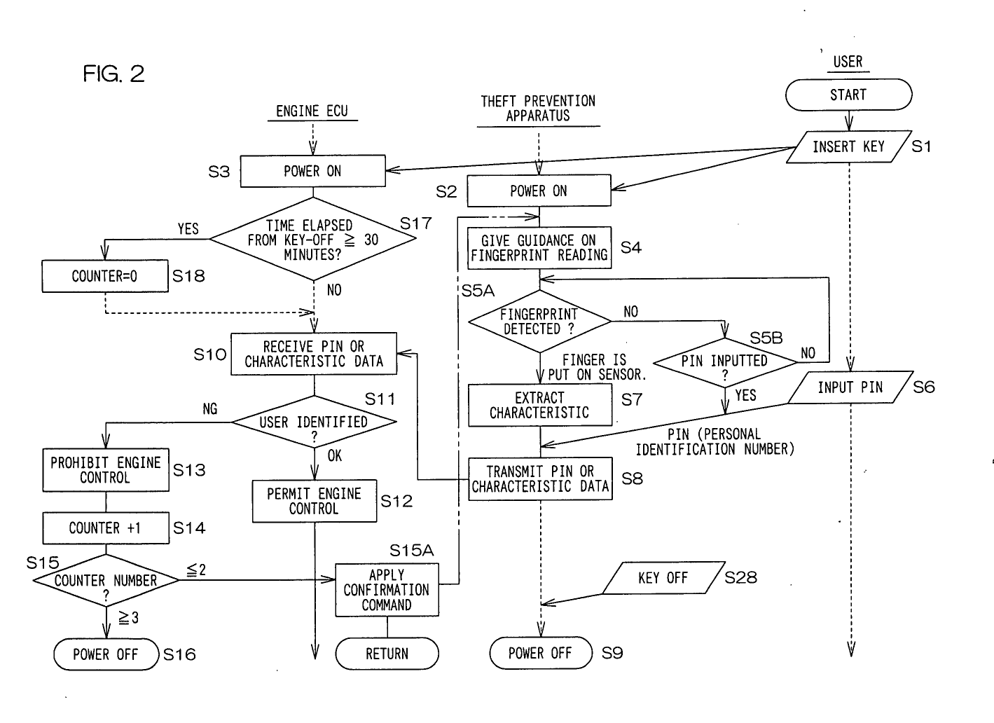

With reference to FIGS. 2 to 8, an explanation of the processes to be performed by the motor vehicle theft prevention system 1 will be provided.

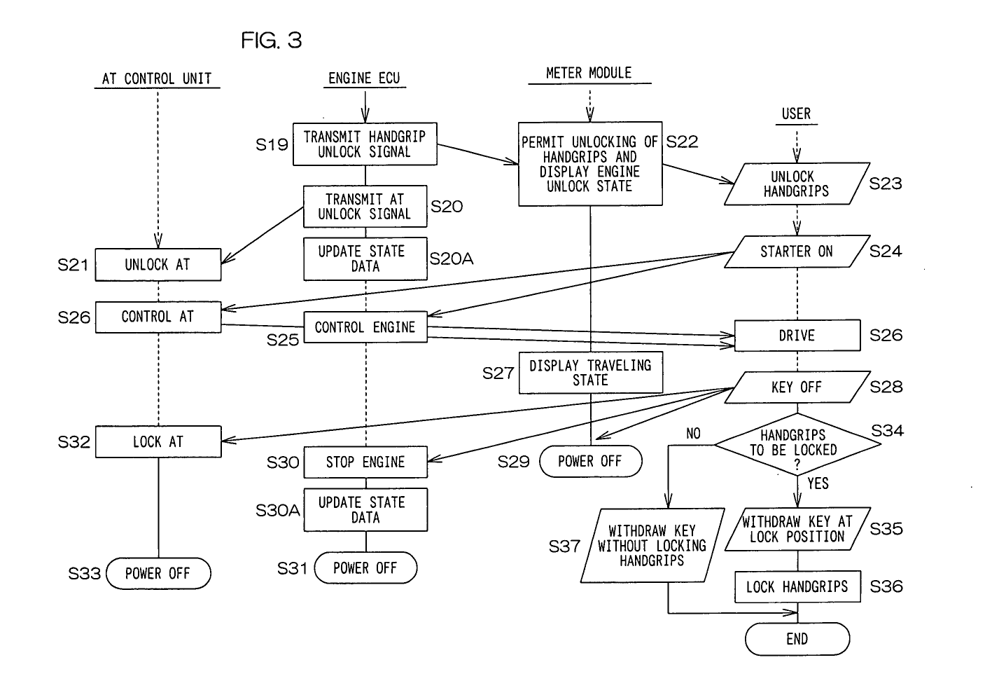

FIGS. 2 and 3 are flow charts for explaining an ordinary process. The ordinary process herein means a process for unlocking the engine from the engine lock state in which the start-up of the engine 4 is prohibited by the function of the motor vehicle theft prevention system 1 to move the motor vehicle and, after stopping or parking the motor vehicle, locking the engine. In the key-off state, the power supply to the theft prevention apparatus 2, the engine ECU 3 and the meter module 6 are off. At this time, the engine ECU 3 is usually in the engine lock state. That is, the state data indicating the engine lock state is written in the state data memories 30M, 20M.

As shown in FIG. 2, the user inserts the ignition key into the key insertion hole 63 of the meter module 6 (Step S1). At this time, a signal indicating the insertion of the ignition key is transmitted to the theft prevention apparatus 2 and the engine ECU 3 through the mobile LAN 9. In response to this signal, the power supply to the theft prevention apparatus 2 is turned on (Step S2), and the power supply to the engine ECU 3 is turned on (Step S3). Then, guidance about the reading of the identification data (for example, fingerprint characteristic data in this case) is provided under the control of the main control section 20 of the theft prevention apparatus 2 (Step S4). For example, an LED (not shown) provided in the fingerprint sensor 21 is lit, or a guidance message “Put your finger on (fingerprint) sensor” is audibly provided from a speaker (not shown) included in the motor vehicle for guidance about the reading. Alternatively, the guidance message may be displayed on the display device 24.

The main control section 20 determines whether or not the fingerprint sensor 21 detects a fingerprint (Step S5A), or determines whether or not a personal identification number is input by operating the numeric keys 231 of the operation buttons 23 (Step S5B). The main control section 20 stands by until the detection of the fingerprint or the input of the personal identification number. If the user inputs the personal identification number by operating the numeric keys 231 prior to the detection of the fingerprint (Step S6), the main control section 20 considers the personal identification number as the identification data to be compared. On the other hand, if it is determined that the user's finger is placed on the fingerprint sensor 21 prior to the input of the personal identification number, the characteristic extracting section 22 extracts the characteristic of the fingerprint to output characteristic data (Step S7). In this case, the main control section 20 considers the characteristic data as the identification data to be compared.

The identification data is transferred to the communication control section 28. The communication control section 28 transmits the identification data (the personal identification number data or the fingerprint characteristic data) to the engine ECU 3 through the mobile LAN 9 (Step S8).

In the engine ECU 3, the communication control section 31 receives the identification data (Step S10). The identification data is temporarily stored in the temporary storage section 38b. The comparing section 36 reads identification reference data from the identification reference data storing section 38a, and compares the identification data stored in the temporary storage section 38b with the identification reference data to determine whether or not the identification data matches with the identification reference data. Thus, it is determined whether or not the identification data has been inputted by an authentic user.

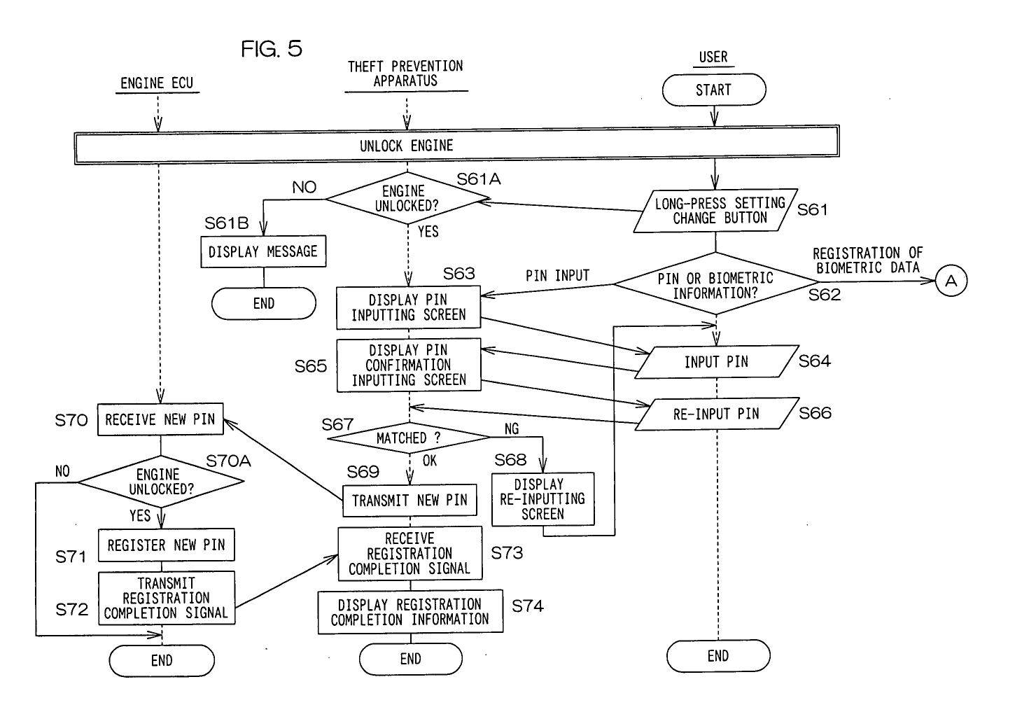

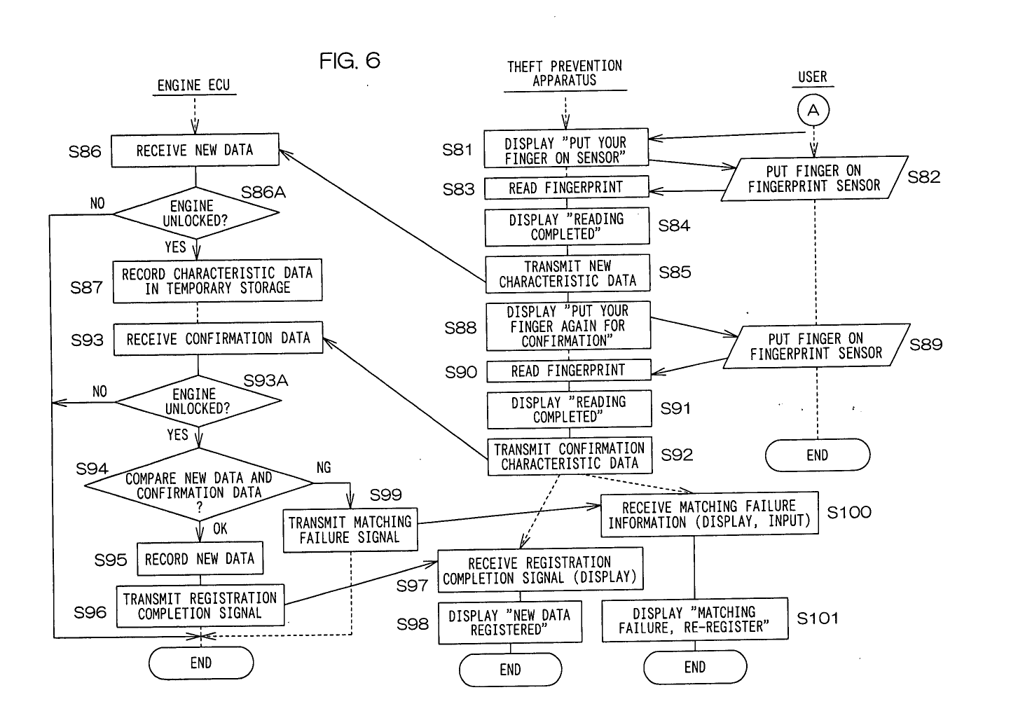

The identification reference data is preliminarily registered in the identification reference data storing section 38a by the authentic user through a registering process (see FIGS. 5 and 6) to be described later. Data of a personal identification number arbitrarily determined by the authentic user (personal identification number reference data) and/or characteristic data of the fingerprint of the authentic user (fingerprint characteristic reference data) may be registered as the identification reference data. The number of authentic users is not limited to one. For example, the owner of the motor vehicle and a person who is permitted to use the motor vehicle by the owner can register their own identification reference data.

If the identification data received from the theft prevention apparatus 2 is personal identification number data, the comparing section 36 reads the personal identification number reference data from the identification reference data storing section 38a. If the identification data received from the theft prevention apparatus 2 is fingerprint characteristic data, the comparing section 36 reads the fingerprint characteristic reference data from the identification reference data storing section 38a.

If the comparing section 36 determines that the inputted identification data matches with the identification reference data (OK in Step S11), the engine control section 39 permits the start-up of the engine 4 in response to the result of the judgment (Step S12). Thus, the state of the engine ECU 3 is switched from the engine lock state to the engine unlock state.

On the other hand, if the comparing section 36 determines that the input identification data does not match the identification reference data (NG in Step S11), the engine control section 39 maintains the engine lock state where the start-up of the engine 4 is prohibited in response to the result of the determination (Step S13). In response to the lack of a matching determination, the main control section 30 increments the count number of the operation number counter 37 by one (Step S14).

The main control section 30 determines if the count number of the operation number counter 37 is not smaller than a predetermined value (three in this preferred embodiment) (Step S15). If the count number is three or greater, the main control section 30 assumes that the user operating the motor vehicle is not authentic, and turns off the power supply to the engine ECU 3 (Step S16). In this case, the engine lock state where the start-up of the engine 4 is prohibited is maintained.

On the other hand, if the count number is two or smaller in Step S15, the main control section 30 applies a command signal for performing an authentication process again beginning from Step S4 to the theft prevention apparatus 2 through the communication control section 31 and the mobile LAN 9 (Step S15A). Thus, the authentication process starting from the step of giving the fingerprint reading guidance to the user is repeated.

Therefore, the lack of a match between the identification data and the identification reference data is permitted twice. However, if the lack of a match is repeated three times, the power supply to the engine ECU 3 is turned off without canceling the engine lock state. In this case, the start-up of the engine 4 is thereafter prohibited for a predetermined period (e.g., 30 minutes) as will be described below.

The main control section 30 determines whether or not the predetermined period (for example, 30 minutes in this preferred embodiment) has elapsed from the previous key-off (the withdrawal of the ignition key from the key insertion hole 63) after the turn-on of the power supply in Step S3 (Step S17). If the time elapsed from the previous key-off is 30 minutes or longer (YES in Step S17), the main control section 30 resets the count number of the operation number counter 37 to zero (Step S18). On the other hand, if the time elapsed from the previous key-off is less than 30 minutes (NO in Step S17), the main control section 30 performs Step S10 and the subsequent steps without resetting the count number of the operation number counter 37. In this case, if the count number of the operation number counter 37 is two or less, the authentication process based on the fingerprint or the personal identification number is started. If the count number is three, the power supply to the engine ECU 3 is immediately turned off.

Thus, the lack of a match between the identification data and the identification reference data attributable to erroneous input or erroneous authentication process performed by the user is permitted twice and, when the lack of a match is determined three times, the authentication process is disabled for 30 minutes. Thus, the start-up of the engine 4 by a thief is effectively prevented, while convenience is offered to the authentic user.

Where the engine control section 39 permits the start-up of the engine 4 in Step S12, the engine control section 39 transmits a handgrip unlock signal to the meter module 6 through the communication control section 31 and the mobile LAN 9 (Step S19 in FIG. 3). The handgrip unlock signal permits the user to unlock handgrips. The unlocking of the handgrips is achieved by the user.

The main control section 30 of the engine ECU 3 transmits an AT unlock signal to the AT control unit 7 from the communication control section 31 through the mobile LAN 9 for unlocking the AT 8 (Step S20). Thus, the AT control unit 7 unlocks the AT 8 (Step S21).

Further, the main control section 30 writes the state data indicating the engine unlock state in the state data memory 30M (Step S20A). At the same time, the main control section 30 outputs the state data to the theft prevention apparatus 2 from the communication control section 31 through the mobile LAN 9. In the theft prevention apparatus 2, the state data is received by the communication control section 28, and transferred to the main control section 20. The main control section 20 writes the state data in the state data memory 20M. Thus, the state data is shared by the engine ECU 3 and the theft prevention apparatus 2, such that the theft prevention apparatus 2 detects the engine locking state (engine lock, engine unlock or function disabled state).

In the meter module 6, the communication control section 67 receives the handgrip unlock signal transmitted from engine ECU 3 through the mobile LAN 9. In response to the reception of the handgrip unlock signal, the display/operation section 65 actuates the handgrip lock device 64 to permit the unlocking of the handgrips. Further, the display/operation section 65 causes the display section 61 to display information about the handgrip unlock state and the engine unlock state (theft preventing function disabled state) (Step S22). Then, the user manually unlocks the handgrips (Step S23). Thereafter, the user switches on the starter button 68 (for a start-up operation) with the ignition key turned to an ON position (Step S24) to start up the engine 4. When the starter button 68 is operated, a start-up command signal is output to the engine ECU 3 and the AT control unit 7 from the communication control section 67 through the mobile LAN 9.

In the engine ECU 3 receiving the start-up command signal from the mobile LAN 9, the engine control section 39 controls the start-up of the engine 4 (Step S25). In the AT control unit 7 receiving the start-up command signal from the mobile LAN 9, the AT control section 72 starts the control of the AT 8 (Step S26). Thus, the user can drive the motor vehicle (Step S26). Further, a traveling state such as a speed is displayed on the display section 61 of the meter module 6 (Step S27).

Even if the starter button 68 is operated, the meter module 6 does not output the start-up command signal without reception of the handgrip unlock signal. As described above, the engine control section 39 of the engine ECU 3 prohibits the start-up of the engine 4, unless it is determined that the identification data matches with the identification reference data. Therefore, even if the start-up command signal is input to the mobile LAN 9, the engine 4 is not started up without the determination that the identification data matches with the identification reference data.

Upon completion of driving, the user performs the key-off operation by turning the ignition key to an OFF position (Step S28). Thus, the power supply to the meter module 6 is turned off (Step S29). At the same time, the engine control section 39 of the engine ECU 3 controls the engine 4 to stop (Step S30). Then, the main control section 30 turns off the power supply to the engine ECU 3 (Step S31). Further, the AT control section 72 of the AT control unit 7 locks the AT 8 (Step S32), and the power supply to the AT control unit 7 is turned off (Step S33). In the theft prevention apparatus 2, the main control section 20 turns off the power supply to the theft prevention apparatus 2 (Step S9 in FIG. 2).

The main control section 30 of the engine ECU 3 writes the state data indicating the engine lock state in the state data memory 30M prior to the turn-off of the power supply (Step S30A). At the same time, the main control section 30 outputs the state data to the theft prevention apparatus 2 from the communication control section 31 through the mobile LAN 9. In the theft prevention apparatus 2, the state data is received by the communication control section 28, and transferred to the main control section 20. The main control section 20 writes the state data in the state data memory 20M. Thus, the state data indicating the engine lock state is retained by both of the engine ECU 3 and the theft prevention apparatus 2.

After the key-off operation (Step S28), the user determines whether or not the handgrips are to be locked (Step S34). If the handgrips are to be locked, the user turns the ignition key to a handgrip lock position and then withdraws the ignition key (Step S35) for locking the handgrips (Step S36). On the other hand, if the handgrips are not to be locked, the user withdraws the ignition key at the key-off position without turning the key to the handgrip lock position (Step S37).

Thus, the process sequence for starting up the engine to drive the motor vehicle and stopping the engine is completed. If the start-up of the engine 4 is to be permitted again by the engine control section 39, the identification data comparing process should be performed. That is, by turning off the power supply to the engine ECU 3, the state of the engine ECU 3 is switched from the engine unlock state where the start-up of the engine 4 is permitted by the engine control section 39 to the engine lock state where the start-up of the engine 4 is prohibited.

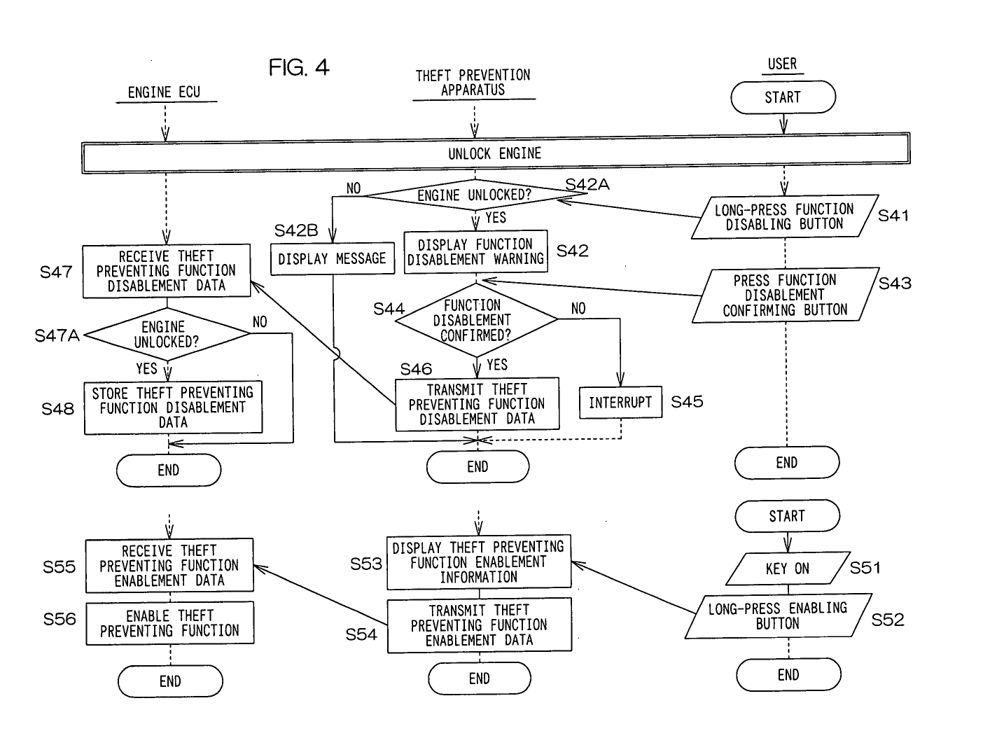

FIG. 4 is a flow chart explaining a process for temporarily disabling the theft preventing function. The theft preventing function can be temporarily disabled in the engine unlock state where the start-up of the engine 4 is permitted in the aforementioned ordinary process.

A person other than the authentic user, for example, an auto mechanic who inspects and repairs the motor vehicle, may want to move the motor vehicle. In this case, the function of the theft prevention apparatus 2 is temporarily disabled. The temporary disablement of the theft preventing function is permitted only when the authentic user performs the authentication process to unlock the engine. Hence, there is no possibility that the theft preventing effect is deteriorated or compromised.

During the temporary disablement of the theft preventing function, the data (the identification reference data including the biometric information and the personal identification number) registered in the identification reference data storing section 38a cannot be updated.

The user first performs the operation shown in FIG. 2 to bring the theft prevention system into the engine unlock state. Then, the user long-presses (continuously presses for 1 second or longer) the function disabling button 232 of the operation buttons 23 of the theft prevention apparatus 2 (Step S41). In response to this button pressing operation, the main control section 20 of the theft prevention apparatus 2 refers to the state data memory 20M to check if the engine is unlocked (Step S42A). The subsequent steps are performed such that the state data indicating the engine unlock state is retained in the state data memory 20M. Otherwise, the main control section 20 causes the display device 24 to display an operation guidance message, for example, “Unlock engine for operation” (Step S42B), and ends the process.

If the engine unlock state is confirmed (YES in Step S42A), the main control section 20 causes the display device 24 to display function disablement warning information including a confirmation message, for example, “Disable theft preventing function?” (Step S42). To prevent inadvertent pressing of the function disabling button 232, the warning is given to the user. A button similar to the function disabling button 232 may be provided on the operation section 62 of the meter module 6.

For reconfirmation of the function disablement, the user presses the function disablement confirming button 233 (Step S43). A button similar to the function disablement confirming button 233 may be provided on the operation section 62 of the meter module 6.

The main control section 20 of the theft prevention apparatus 2 determines whether or not the function disablement confirming button 233 is operated (Step S44), while the display device 24 displays the function disablement warning message. If the function disablement confirming button 233 is not pressed within a predetermined period after the display of the function disablement warning message (NO in Step S44), the function disabling process is interrupted (Step S45). On the other hand, if the function disablement confirming button 233 is pressed within the predetermined period (YES in Step S44), the main control section 20 transmits theft preventing function disablement data to the engine ECU 3 from the communication control section 28 through the mobile LAN 9 (Step S46).

In the engine ECU 3, the communication control section 31 receives the theft preventing function disablement data (Step S47). In response to the reception of the theft preventing function disablement data, the main control section 30 refers to the state data stored in the state data memory 30M. If the state data does not indicate the engine unlock state (i.e., the state data is indicating the engine lock state) (NO in Step S47A), the main control section 30 keeps the engine ECU 3 in the engine lock state without disabling the theft preventing function. Therefore, the theft preventing function is not disabled. This operation may be performed, for example, where a third person inputs theft preventing function disablement data to the mobile LAN 9 from a signal generator. In this case, the start-up of the engine 4 is prohibited, because the engine ECU 3 is kept in the engine lock state without the disablement of the theft preventing function.

On the other hand, if the state data stored in the state data memory 30M is indicating the engine unlock state (YES in Step S47A), the main control section 30 stores the received theft preventing function disablement data in the temporary storage section 38b (Step S48). When the theft preventing function disablement data is stored in the temporary storage section 38b, the main control section 30 applies a command signal for temporarily disabling the theft preventing function to the engine control section 39. At this time, the engine control section 39 maintains the engine ECU 3 in the state where the start-up of the engine 4 is permitted irrespective of the judgment made by the comparing section 36, as long as the power supply to the engine ECU 3 is on. In the engine unlock state, the function of the theft prevention apparatus 2 is thus temporarily disabled. Even if the power supply to the engine ECU 3 is turned off, the theft preventing function disablement data is retained in the temporary storage section 38b. Therefore, when the power supply to the engine ECU 3 is turned on again, the engine 4 can be started up without the authentication process based on the identification data.

When the theft preventing function is temporarily disabled, the main control section 30 writes the state data indicating the temporary disablement of the theft preventing function in the state data memory 30M. Further, the state data is transferred to the theft prevention apparatus 2 through the mobile LAN 9, and written in the state data memory 20M by the main control section 20.

If the key-off operation is performed when the state data indicating the theft preventing function disablement state is stored in the state data memory 20M, the main control section 20 of the theft prevention apparatus 2 causes the display device 24 to display warning information to indicate that the theft preventing function is off before the power supply is turned off.

With reference to FIG. 4, an explanation will be given of a process for restoring the theft preventing function once disabled. In this process, the identification reference data (the biometric information and the personal identification number) stored in the identification reference data storing section 38a cannot be updated.

First, the user performs a key-on operation (Step S51), and long-presses the enabling button 234 of the operation buttons 23 of the theft prevention apparatus 2 (Step S52). Then, the main control section 20 of the theft prevention apparatus 2 causes the display device 24 to display information of the enablement of the theft preventing function including a guidance message such as “Theft preventing function enabled” (Step S53). Then, the main control section 20 of the theft prevention apparatus 2 transmits theft preventing function enablement data to the engine ECU 3 from the communication control section 28 through the mobile LAN 9 (Step S54). In the engine ECU 3, the communication control section 31 receives the theft preventing function enablement data (Step S55). Then, the theft preventing function disablement data registered in Step S48 is deleted from the temporary storage section 38B, and the theft preventing function is enabled (Step S56). Through this process, the function of the theft prevention apparatus 2 that has been disabled can be restored.

A button similar to the enabling button 234 may be provided on the operation section 62 of the meter module 6.

Upon the enablement of the theft preventing function, the main control section 30 of the engine ECU 3 writes the state data indicating the engine unlock state in the state data memory 30M. The state data is further transmitted to the theft prevention apparatus 2 through the mobile LAN 9, and written in the state data memory 20M by the main control section 20.

FIGS. 5 and 6 are flow charts for explaining a process for registering new identification reference data (biometric information such as fingerprint characteristic data or a personal identification number) in the identification reference data storing section of the engine ECU 3. The process for the registration of new identification reference data or change of the identification reference data cannot be performed, unless the engine is unlocked through the process shown in FIG. 2. The registration or change of the identification reference data is prohibited not only when the engine is locked but also when the theft preventing function is temporarily disabled through the process shown in FIG. 4. In the case of a newly purchased motor vehicle, the engine is unlocked by inputting a factory-preset personal identification number for the registration or change of the identification reference data.

Therefore, the user first unlocks the engine through the process shown in FIG. 2. Then, the user long-presses the setting change button 235 of the operation buttons 23 of the theft prevention apparatus 2 (Step S61). A similar setting change button may be provided on the operation section 62 of the meter module 6.

When the setting change button 235 is long-pressed, the theft prevention apparatus 2 determines whether or not the engine is unlocked (Step S61A). More specifically, the main control section 20 refers to the state data memory 20M. The subsequent steps are performed as long as the state data indicating the engine unlock state is retained in the state data memory 20M. Otherwise, the main control section 20 causes the display device 24 to display an operation guidance message, for example, “Unlock engine for operation” (Step S61B), and ends the process.

If the engine is unlocked, the user is permitted to perform the subsequent operation. That is, the user determines which of a personal identification number and biometric information is to be registered (Step S62). If the personal identification number is to be registered, the user presses the personal identification number setting button 236 of the operation buttons 23 of the theft prevention apparatus 2. Then, the main control section 20 causes the display device 24 to display a personal identification number inputting screen including an operation guidance message, for example, “Input new personal identification number,” and the numeric keys 231 (Step S63).

Subsequently, the user presses the numeric keys 231 (personal identification number inputting buttons) out of the operation buttons 23 of the theft prevention apparatus 2 or the buttons of the operation section 62 of the meter module 6 for inputting the personal identification number (Step S64). In the theft prevention apparatus 2 receiving the input, the main control section 20 causes the display device 24 to display a personal identification number confirmation inputting screen including an operation guidance message, for example, “Re-input for confirmation,” and the numeric keys 231 (Step S65).

Then, the user inputs the same personal identification number again (Step S66). In the theft prevention apparatus 2 receiving the input, the main control section 20 determines whether or not the two personal identification numbers input in Steps S64 and S66 match with each other (Step S67). If it is determined that these two personal identification numbers do not match with each other (NG in Step S67), the main control section 20 causes the display device 24 to display a personal identification number re-inputting screen including an operation guidance message, for example, “Wrong number, re-input personal identification number,” and the numeric keys 231 (Step S68). Then, the user is required to perform the operation starting from Step S64. The theft prevention apparatus 2 is ready to receive the re-input of the personal identification number.

If it is determined that the re-inputted personal identification number matches with the previously inputted personal identification number (YES in Step S67), the main control section 20 transmits new personal identification number data as the identification reference data to the engine ECU 3 from the communication control section 28 through the mobile LAN 9 (Step S69). In the engine ECU 3, the communication control section 31 receives the new personal identification number data (Step S70).

In response to the reception of the new personal identification number data, the main control section 30 refers to the state data stored in the state data memory 30M. If the state data is not indicative of the engine unlock state (i.e., the state data is indicative of the engine lock state) (NO in Step S70A), the main control section 30 maintains the engine ECU 3 in the engine lock state without registering the personal identification number data. This operation may be performed, for example, when a third person inputs personal identification number data to the mobile LAN 9 from a signal generator. In this case, the registration of the new personal identification number and change of the personal identification number is prevented.

On the other hand, if the state data stored in the state data memory 30M indicates the engine unlock state (YES in Step S70A), the main control section 30 registers the received new personal identification number data in the identification reference data storing section 38a (Step S71). Thereafter, the main control section 30 transmits a registration completion signal to the theft prevention apparatus 2 from the communication control section 31 through the mobile LAN 9 (Step S72). In the theft prevention apparatus 2, the communication control section 28 receives the registration completion signal (Step S73). Then, the main control section 20 of the theft prevention apparatus 2 causes the display device 24 to display information of the completion of the registration including a guidance message, for example, “New personal identification number registered” (Step S74).

A plurality of personal identification numbers may be registered as the personal identification number data in the identification reference data storing section 38a. However, it is preferred to allow for registration of only one personal identification number from the viewpoint of enhancement of the theft preventing effect. That is, it is preferred that the personal identification number data previously registered in the identification reference data storing section 38a is deleted and the new personal identification number data is registered in the identification reference data storing section 38a by performing the aforementioned operation.

Where the biometric information such as fingerprint characteristic data is to be registered, the process is branched from Step S62 to perform a biometric information registering process shown in FIG. 6. That is, the user presses the biometric information registering button 237 out of the operation buttons 23 of the theft prevention apparatus 2. Then, the main control section 20 of the theft prevention apparatus 2 causes the display device 24 to display a screen including an operation guidance message, for example, “Put your finger on sensor” (Step S81), shown in FIG. 6.

The user is prompted by this message to put a finger on the fingerprint sensor 21 (Step S82). Then, a fingerprint reading operation is performed in the theft prevention apparatus 2 (Step S83). That is, characteristic data of a fingerprint detected by the fingerprint sensor 21 is generated by the characteristic extracting section 22. Upon completion of the reading operation, the main control section 20 causes the display device 24 to display information of the completion of the reading (Step S84). Then, the main control section 20 transmits the new fingerprint characteristic data as the identification reference data to the engine ECU 3 from the communication control section 28 through the mobile LAN 9 (Step S85). In the engine ECU 3, the communication control section 31 receives the new characteristic data (Step S86).

In response to the reception of the characteristic data, the main control section 30 refers to the state data stored in the state data memory 30M. If the state data is not indicative of the engine unlock state (the state data is indicative of the engine lock state) (NO in Step S86A), the main control section 30 rejects acceptance of the received characteristic data, and maintains the engine ECU 3 in the engine lock state. This operation may be performed, for example, where a third person inputs characteristic data to the mobile LAN 9 from a signal generator. In this case, the registration and change of the characteristic data as the identification reference data is prevented.

If the state data stored in the state data memory 30M is indicative of the engine unlock state (YES in Step S86A), the main control section 30 records the received characteristic data in the temporary storage section 38b (Step S87).

On the other hand, the main control section 20 of the theft prevention apparatus 2 causes the display device 24 to display a screen including an operation guidance message, for example, “Put your finger again for confirmation” (Step S88).

The user is prompted by this message to place a finger on the fingerprint sensor 21 again (Step S89). In the theft prevention apparatus 2, the characteristic extracting section 22 performs the fingerprint reading operation (Step S90), and extracts characteristic data of the fingerprint. Upon completion of the reading operation, the main control section 20 causes the display device 24 to display information regarding the completion of the reading (Step S91). Then, the characteristic data of the read fingerprint is transmitted as confirmation data to the engine ECU 3 from the communication control section 28 through the mobile LAN 9 (Step S92). In the engine ECU 3, the communication control section 31 receives the confirmation characteristic data (Step S93).

In response to the reception of the confirmation characteristic data, the main control section 30 refers to the state data stored in the state data memory 30M. If the state data does not indicate the engine unlock state (NO in Step S93A), the main control section 30 rejects acceptance of the received characteristic data, and maintains the engine ECU 3 in the engine lock state. If the state data stored in the state data memory 30M indicates the engine unlock state (YES in Step S93A), the main control section 30 causes the comparing section 36 to compare the confirmation characteristic data received in Step S93 with the characteristic data previously stored in the temporary storage section 38b (Step S94). If it is determined as the result of the comparison that the input data that is input first and the input data that is input second match with each other (OK in Step S94), the new characteristic data is recorded in the identification reference data storing section 38a (Step S95). Then, the main control section 30 transmits a registration completion signal to the theft prevention apparatus 2 from the communication control section 31 through the mobile LAN 9 (Step S96). In the theft prevention apparatus 2, the communication control section 28 receives the registration completion signal (Step S97). In response to the reception of the registration completion signal, the main control section 20 causes the display device 24 to display information of the completion of the registration including a guidance message, for example, “New (fingerprint) data registered” (Step S98).

On the other hand, if it is determined that the aforementioned two characteristic data do not match with each other (NG in Step S94), the main control section 30 of the engine ECU 3 transmits a matching failure signal to the theft prevention apparatus 2 from the communication control section 31 through the mobile LAN 9 (Step S99). In the theft prevention apparatus 2, the communication control section 28 receives the matching failure signal (Step S100). Then, the main control section 20 of the theft prevention apparatus 2 causes the display device 24 to display a registration prompting screen including an operation guidance message, for example, “Matching failure, re-register fingerprint” (Step S101).

Through the process described above, the registration of the identification reference data is permitted when the engine is unlocked. In this preferred embodiment, no identification data comparing unit is provided in the theft prevention apparatus 2, however, the comparing section 36 for comparing the identification data is provided in the engine ECU 3. Therefore, the process for comparing the input identification data input first and the input identification data input second for the registration of the identification reference data is performed in the engine ECU 3. The personal identification number comparing operation is relatively easy, such that the comparing operation for the registration of the personal identification number reference data is performed in the theft prevention apparatus 2 in this preferred embodiment. Alternatively, the comparing operation for the registration of the personal identification number reference data may be performed in the engine ECU 3.

The main control section 30 of the engine ECU 3 is permitted to accept the received new identification reference data (Steps S70, S86) when the state data indicating the engine unlock state is stored in the state data memory 30M. That is, when the state data stored in the state data memory 30M is indicative of the engine lock state or the theft preventing function disabled state, the acceptance of the new identification reference data transmitted through the mobile LAN 9 is rejected, such that the registration and change of the identification reference data is prevented. Therefore, it is impossible to add or write identification reference data in the identification reference data storing section 38a of the engine ECU 3, for example, by connecting a personal computer to the mobile LAN 9, unless the authentic user performs the engine unlocking operation.

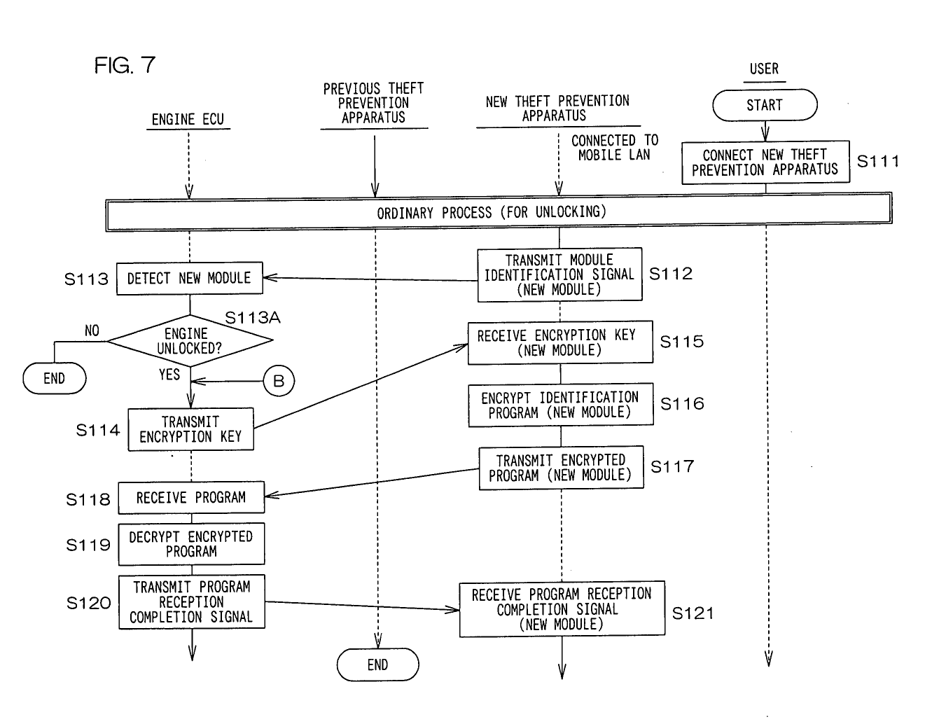

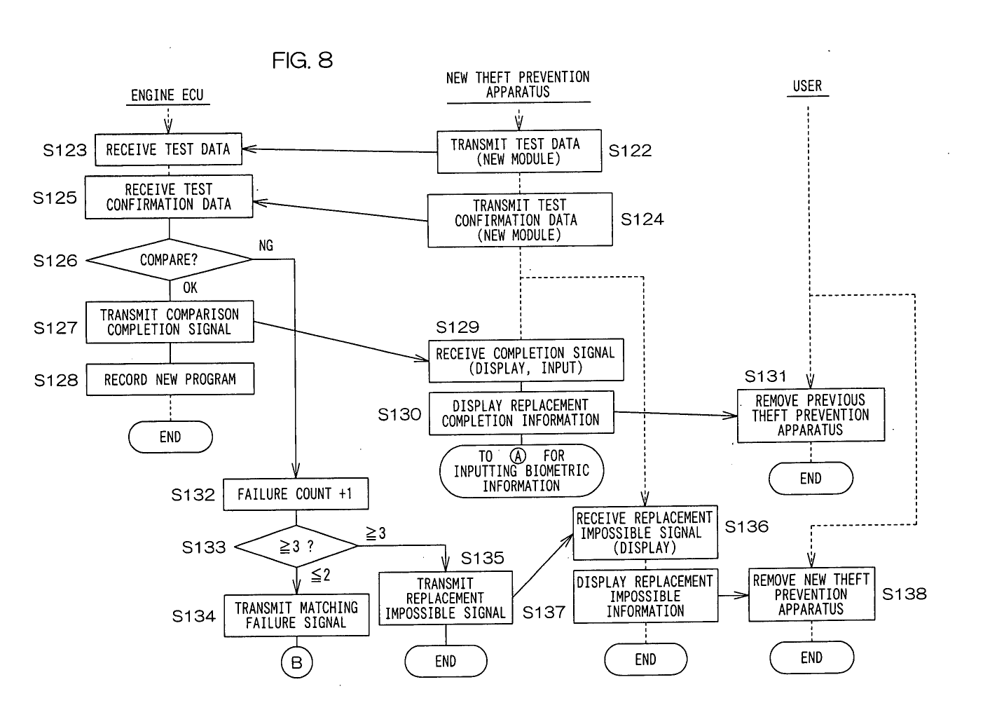

FIGS. 7 and 8 are flow charts of a process for replacing the theft prevention apparatus 2 with a new theft prevention apparatus 5. The theft prevention apparatus is replaced, for example, when the fingerprint sensor 21 of the theft prevention apparatus 2 malfunctions or when an improved theft prevention apparatus capable of performing the fingerprint reading operation using a higher performance sensor or performing an improved functional characteristic extracting operation is developed. In each case, it is necessary to replace only the theft prevention apparatus without replacing the engine ECU 3, even though the identification data comparing operation is performed in the engine ECU 3 in this preferred embodiment. Therefore, the theft prevention system has an economic advantage.

The replacement of the theft prevention apparatus is prohibited, unless the engine is unlocked through the process shown in FIG. 2. The replacement of the theft prevention apparatus is also prohibited, if the theft preventing function is temporarily disabled through the process shown in FIG. 4.

Therefore, the user first unlocks the engine via the process shown in FIG. 2. Then, the user connects the new theft prevention apparatus 5 to the mobile LAN 9 (Step S111). The main control section 50 of the new theft prevention apparatus 5 transmits a module identification signal to the engine ECU 3 from the communication control section 58 through the mobile LAN 9 (Step S112). The module identification signal defines a unique identification number that is assigned to each theft prevention apparatus and utilized for identification of the theft prevention apparatus.

In the engine ECU 3, the communication control section 31 receives the new module identification signal. The module identification signal is transferred to the main control section 30. Upon reception of the module identification signal, the main control section 30 determines that a new theft prevention apparatus 5 is connected (Step S113). The main control section 30 accesses the state data memory 30M to determine whether or not the engine is unlocked. If the engine is not unlocked, the received module identification signal is ignored, and the subsequent steps are not performed (Step S113A). Alternatively, the main control section 30 may transmit a replacement impossible signal to the new theft prevention apparatus 5 from the communication control section 31 through the mobile LAN 9 (Step S135). In this case, the communication control section 58 of the new theft prevention apparatus 5 receives the replacement impossible signal (Step S136). In response to the reception of the replacement impossible signal, the main control section 50 causes the display device 54 to display replacement impossible information (Step S137). Thus, the user cannot install the new theft prevention apparatus 5, and must remove the new theft prevention apparatus 5 from the mobile LAN 9 (Step S138).

If the state data indicating the engine unlock state is stored in the state data memory 30M (YES in Step S113A) and the engine unlock state is therefore confirmed, then the main control section 30 causes the encryption key generating section 33 to generate encryption key data. The encryption key data is transmitted to the new theft prevention apparatus 5 from the communication control section 31 through the mobile LAN 9 (Step S114). In the new theft prevention apparatus 5, the communication control section 58 receives the encryption key data. The encryption key data is recorded in the encryption key data storing section 55 (Step S115). The main control section 50 of the new theft prevention apparatus 5 reads an identification program for the new theft prevention apparatus 5 from the identification program storing section 57, and inputs the identification program to the encrypting section 56. The encrypting section 56 encrypts the identification program using the encryption key data recorded in the encryption key data storing section 55 (Step S116). The encrypted identification program is transmitted to the engine ECU 3 from the communication control section 58 through the mobile LAN 9 (Step S117).

In the engine ECU 3, the communication control section 31 receives the encrypted identification program (Step S118). The encrypted identification program is transferred to the decrypting section 34. The decrypting section 34 decrypts the encrypted identification program based on decryption key data corresponding to the encryption key data generated by the encryption key generating section 33 (Step S119). Upon completion of the decryption, the main control section 30 transmits a program reception completion signal to the new theft prevention apparatus 5 from the communication control section 31 through the mobile LAN 9 (Step S120).

The encryption key data and the decryption key data may be identical to each other. However, illegal decryption of the identification program is generally prevented by setting the encryption key data and the decryption key data differently. Where a public key system is used, for example, the encryption key data appearing on the mobile LAN 9 corresponds to public key data, and the decryption key data retained in the engine ECU 3 corresponds to secret key data. In this case, it is impossible to decrypt the encrypted identification program with the use of the encryption key data. Even if the encryption key data appearing on the mobile LAN 9 is intercepted, the encrypted identification program cannot be decrypted.

Then, the communication control section 58 of the new theft prevention apparatus 5 receives the program reception completion signal from the engine ECU 3 (Step S121). The main control section 50 transmits test data to the engine ECU 3 from the communication control section 58 through the mobile LAN 9 as shown in FIG. 8 (Step S122). In the engine ECU 3, the test data is received by the communication control section 31, and recorded in the temporary storage section 38b (Step S123). The test data is dummy identification data, which is used to determine whether or not signals from the new theft prevention apparatus 5 are correctly read and processed by the engine ECU 3.

Subsequently, the main control section 50 of the new theft prevention apparatus 5 transmits test confirmation data to the engine ECU 3 from the communication control section 58 through the mobile LAN 9 (Step S124). In the engine ECU 3, the communication control section 31 receives the test confirmation data (Step S125). The test confirmation data is also dummy identification data, but different from the aforementioned test data. When the same user places the same finger on the fingerprint sensor, for example, the result of the characteristic extraction slightly varies depending on how the finger is placed on the sensor. Thus, the fingerprint characteristic data defining the identification data does not always have the same value. Therefore, a test for the comparing the process is performed by transmitting the test data and the test confirmation data slightly differently from each other to the engine ECU 3.

In the engine ECU 3, the comparing section 36 compares the test confirmation data received in Step S125 with the test data previously stored in the temporary storage section 38b (Step S126). If it is determined, as a result of the comparison, that the test data and the test confirmation data match each other (OK in Step S126), the main control section 30 transmits a comparison completion signal to the new theft prevention apparatus 5 from the communication control section 31 through the mobile LAN 9 (Step S127). At the same time, the main control section 30 records a decrypted identification program in the identification program storing section 35 (Step S128). The comparing section 36 of the engine ECU 3 thereafter performs the identification data comparing process according to the identification program for the new theft prevention apparatus 5. That is, the identification data comparing process to be performed by the comparing section 36 is exclusive to the new theft prevention apparatus 5.

In the previous theft prevention apparatus 2, the communication control section 28 receives the comparison completion signal (Step S129). In response to the reception of the comparison completion signal, the main control section 20 causes the display device 24 to display information regarding the completion of the replacement (Step S130). Then, the user removes the previous theft prevention apparatus 2 from the mobile LAN 9 (Step S131). Thereafter, the user performs the operation starting from Step S81 shown in FIG. 6 for registering identification reference data (fingerprint characteristic data) with the new theft prevention apparatus 5.

On the other hand, if the comparing section 36 determines that the test data and the test confirmation data do not match each other (NG in Step S128), the main control section 30 increments the number of matching failures counted by the operation number counter 37 by one (Step S132). The main control section 30 determines if the count number of the operation number counter 37 is 3 or more (Step S133). If the count number of the operation number counter 37 is 2 or less, the main control section 30 transmits a matching failure signal to the new theft prevention apparatus 5 from the communication control section 31 through the mobile LAN 9 (Step S134), and performs the operation again starting from Step S114. On the other hand, if it is determined in Step S133 that the count number of the operation number counter 37 is 3 or more, the main control section 30 determines that the new theft prevention apparatus 5 is defective, and transmits a replacement impossible signal to the new theft prevention apparatus 5 from the communication control section 31 through the mobile LAN 9 (Step S135).

In the new theft prevention apparatus 5, the communication control section 58 receives the replacement impossible signal (Step S136). In response to the reception of the replacement impossible signal, the main control section 50 causes the display device 54 to display the replacement impossible information (Step S137). Then, the user terminates the attempts to replace the old theft prevention apparatus 2 with the new theft prevention apparatus 5, and removes the new theft prevention apparatus 5 from the mobile LAN 9 (Step S138).

Using the aforementioned process, the previous theft prevention apparatus 2 is replaced with the new theft prevention apparatus 5 if the engine is unlocked by the authentic user.

According to this preferred embodiment, as described above, the theft prevention apparatus 2 does not determine the authenticity of the input identification data (fingerprint characteristic data or personal identification number data), but transmits the identification data as it is to the engine ECU 3. Then, the engine ECU 3 performs the identification data comparing process to determine whether or not the user inputting the identification data is the authentic data. Therefore, even if an engine start-up command signal is input to the mobile LAN 9 from a signal generator, it is impossible to start the engine 4. This makes it very difficult for a thief to steal the motor vehicle. Thus, the theft prevention system has a greatly improved theft preventing effect.

In this preferred embodiment, the identification program, which is retained in the theft prevention apparatus 2, 5, is preferably transmitted to the engine ECU 3 and registered in the engine ECU 3. Thus, the comparing section 36 of the engine ECU 3 can perform an identification data comparing process that is specific to the theft prevention apparatus 2, 5 connected to the mobile LAN 9. Even if the previous theft prevention apparatus 2 is replaced with the new theft prevention apparatus 5, a theft prevention system utilizing the new theft prevention apparatus 5 can be provided without the need to replace the engine ECU 3.

While preferred embodiments of the present invention have been described, the present invention not restricted to these preferred embodiments. Although the description has been provided with respect to a system for preventing the theft of the motor vehicle having an engine as the power source in the preferred embodiments described above, the present invention is applicable to a movable body which is adapted to be moved by any other power source, such as an electric motor.

While the present invention has been described in detail with reference to preferred embodiments thereof, it should be understood that the foregoing disclosure is merely illustrative of the technical principles of the present invention, and the present invention is not limited to the preferred embodiments described above. The spirit and scope of the present invention are limited only by the claims presented below.

This application corresponds to Japanese Patent Application No. 2003-338253 filed with the Japanese Patent Office on Sep. 29, 2003, the disclosure of which is incorporated herein by reference.

1. A theft prevention system comprising:
a theft prevention apparatus for preventing theft of a movable body;
a power source controller which controls a power source for moving the movable body; and
a communication line that connects the theft prevention apparatus and the power source controller for data communication; wherein
the theft prevention apparatus includes:
an identification data inputting unit into which a user inputs identification data; and
an identification data transmitting unit which transmits the identification data input into the identification data inputting unit to the power source controller through the communication line;
the power source controller includes:
an identification data receiving unit which receives the identification data transmitted from the identification data transmitting unit through the communication line;
an identification reference data storing unit which stores identification reference data to be compared with the identification data received by the identification data receiving unit;
an identification data comparing unit which performs a comparing process for comparing the identification data received by the identification data receiving unit with the identification reference data stored in the identification reference data storing unit and determining whether the user inputting the identification data is an authentic user; and
a start-up controlling unit which permits start-up of the power source when the identification data comparing unit determines that the user inputting the identification data is the authentic user.

2. A theft prevention system as set forth in claim 1, wherein the theft prevention apparatus further includes:
a first identification program storing unit which stores an identification program defining the comparing process to be performed by the identification data comparing unit; and
an identification program transmitting unit which transmits the identification program stored in the first identification program storing unit to the power source controller through the communication line;
the power source controller further includes:
an identification program receiving unit which receives the identification program transmitted from the identification program transmitting unit through the communication line; and
a second identification program storing unit which stores the identification program received by the identification program receiving unit; and
the identification data comparing unit includes a program implementing unit which performs the comparing process according to the identification program stored in the second identification program storing unit.

3. A theft prevention system as set forth in claim 2, wherein the power source controller has at least a start-up lock state where the start-up of the power source is prohibited by the start-up controlling unit and a start-up unlock state where the start-up of the power source is permitted by the start-up controlling unit, the power source controller enters the start-up unlock state when the identification data comparing unit determines that the user inputting the identification data is the authentic user;
the power source controller further includes a unit which permits writing of the identification program to the second identification program storing unit when the power source controller is in the start-up unlock state, and prohibits the writing of the identification program to the second identification program storing unit when the power source controller is in a state other than the start-up unlock state.

4. A theft prevention system as set forth in claim 2, wherein the theft prevention apparatus further includes an identification program encrypting unit which encrypts the identification program stored in the first identification program storing unit, and the identification program transmitting unit transmits the identification program encrypted by the identification program encrypting unit to the power source controller through the communication line;
the identification program receiving unit receives the encrypted identification program; and
the power source controller further includes an identification program decrypting unit which decrypts the encrypted identification program, and the second identification program storing unit stores the identification program decrypted by the identification program decrypting unit.

5. A theft prevention system as set forth in claim 4, wherein the power source controller further includes an encryption key generating unit which generates encryption key data to be used for the encryption of the identification program, and a unit which transmits the encryption key data generated by the encryption key generating unit to the theft prevention apparatus through the communication line;
the theft prevention apparatus further includes a unit which receives the encryption key data transmitted from the power source controller through the communication line;
the identification program encrypting unit encrypts the identification program with a use of the received encryption key data; and
the identification program decrypting unit decrypts the encrypted identification program with a use of decryption key data corresponding to the encryption key data.

6. A theft prevention system as set forth in claim 1, wherein the identification data inputting unit includes a biometric information detecting unit which detects biometric information of the user and outputs the detected biometric information as the identification data.

7. A theft prevention apparatus which is mountable on a movable body including a power source controller for controlling a power source for moving the movable body and a communication line connected to the power source controller for data communication, and is connectable to the communication line for data communication, the theft prevention apparatus comprising:
an identification data inputting unit into which a user inputs identification data; and
an identification data transmitting unit which transmits the identification data input into the identification data inputting unit to the power source controller through the communication line.

8. A theft prevention apparatus as set forth in claim 7, further comprising:
an identification program storing unit which stores an identification program defining a process for comparison of the identification data input into the identification data inputting unit; and
an identification program transmitting unit which transmits the identification program stored in the identification program storing unit to the power source controller through the communication line.

9. A theft prevention apparatus as set forth in claim 8, further comprising:
a unit which receives encryption key data transmitted from the power source controller through the communication line; and
an identification program encrypting unit which encrypts the identification program stored in the identification program storing unit with a use of the received encryption key data; wherein
the identification program transmitting unit transmits the identification program encrypted by the identification program encrypting unit to the power source controller through the communication line.

10. A theft prevention apparatus as set forth in claim 7, wherein the identification data inputting unit includes a biometric information detecting unit which detects biometric information of the user and outputs the detected biometric information as the identification data.

11. A power source controller for controlling a power source for moving a movable body and for data communication with a theft prevention apparatus through a communication line provided in the movable body, the power source controller comprising:
an identification data receiving unit which receives identification data input by a user from the theft prevention apparatus through the communication line;
an identification reference data storing unit which stores identification reference data to be compared with the identification data received by the identification data receiving unit;
an identification data comparing unit which performs a comparing process for comparing the identification data received by the identification data receiving unit with the identification reference data stored in the identification reference data storing unit and judging whether the user inputting the identification data is an authentic user; and
a start-up controlling unit which permits start-up of the power source if the identification data comparing unit determines that the user inputting the identification data is the authentic user.

12. A power source controller as set forth in claim 11, further comprising:
an identification program receiving unit which receives an identification program transmitted from the theft prevention apparatus through the communication line; and
an identification program storing unit which stores the identification program received by the identification program receiving unit; wherein
the identification data comparing unit includes a program implementing unit which performs the comparing process according to the identification program stored in the identification program storing unit.

13. A power source controller as set forth in claim 12, wherein the power source controller has at least a start-up lock state where the start-up of the power source is prohibited by the start-up controlling unit and a start-up unlock state where the start-up of the power source is permitted by the start-up controlling unit, the power source controller enters the start-up unlock state when the identification data comparing unit determines that the user inputting the identification data is the authentic user; and
the power source controller further includes a unit which permits writing of the identification program to the identification program storing unit if the power source controller is in the start-up unlock state, and prohibits the writing of the identification program to the identification program storing unit when the power source controller is in a state other than the start-up unlock state.

14. A power source controller as set forth in claim 12, wherein the theft prevention apparatus transmits an encrypted identification program to the power source controller through the communication line;
the power source controller further comprising:
an encryption key generating unit which generates encryption key data to be used for encryption of the identification program;
a unit which transmits the encryption key data generated by the encryption key generating unit to the theft prevention apparatus through the communication line; and
an identification program decrypting unit which decrypts the encrypted identification program with a use of decryption key data corresponding to the encryption key data; and
the identification program storing unit stores the identification program decrypted by the identification program decrypting unit.

15. A transport vehicle having a power source for movement thereof, the transport vehicle comprising:
a theft prevention apparatus for preventing theft of the transport vehicle;
a power source controller which controls the power source; and
a communication line which connects the theft prevention apparatus and the power source controller for data communication; wherein
the theft prevention apparatus includes:
an identification data inputting unit into which a user inputs identification data; and
an identification data transmitting unit which transmits the identification data inputted into the identification data inputting unit to the power source controller through the communication line; wherein
the power source controller includes:
an identification data receiving unit which receives the identification data transmitted from the identification data transmitting unit through the communication line;
an identification reference data storing unit which stores identification reference data to be compared with the identification data received by the identification data receiving unit;
an identification data comparing unit which performs a comparing process for comparing the identification data received by the identification data receiving unit with the identification reference data stored in the identification reference data storing unit and judging whether the user inputting the identification data is an authentic user; and
a start-up controlling unit which permits start-up of the power source if the identification data comparing unit determines that the user inputting the identification data is the authentic user.

16. A transport vehicle as set forth in claim 15, wherein the theft prevention apparatus further includes:
a first identification program storing unit which stores an identification program defining the comparing process to be performed by the identification data comparing unit; and
an identification program transmitting unit which transmits the identification program stored in the first identification program storing unit to the power source controller through the communication line;
the power source controller further includes:
an identification program receiving unit which receives the identification program transmitted from the identification program transmitting unit through the communication line; and
a second identification program storing unit which stores therein the identification program received by the identification program receiving unit;
the identification data comparing unit includes a program implementing unit which performs the comparing process according to the identification program stored in the second identification program storing unit.

17. A theft prevention method comprising the steps of:
connecting a theft prevention apparatus to a power source controller through a communication line for data communication, the theft prevention apparatus preventing theft of a movable body, the power source controller controlling a power source for moving the movable body;
allowing a user to input identification data into an identification data inputting unit provided in the theft prevention apparatus;
transmitting the identification data input into the identification data inputting unit to the power source controller through the communication line;
storing identification reference data in an identification reference data storing unit provided in the power source controller;
causing an identification data comparing unit provided in the power source controller to perform an identification data comparing process for comparing the identification data transmitted from the theft prevention apparatus through the communication line with the identification reference data stored in the identification reference data storing unit and judging whether the user inputting the identification data is an authentic user; and
permitting start-up of the power source if it is determined in the identification data comparing step that the user inputting the identification data is the authentic user.

18. A theft prevention method as set forth in claim 17, further comprising the steps of:
transmitting an identification program defining the comparing process to be performed by the identification data comparing unit to the power source controller from the theft prevention apparatus through the communication line; and
storing the identification program in an identification program storing unit provided in the power source controller; wherein
the identification data comparing step includes the step of comparing the identification data transmitted from the theft prevention apparatus with the identification reference data stored in the identification reference data storing unit according to the identification program stored in the identification program storing unit.
